(19) United States
(12) Patent Application Publication
(10) Pub. No.: US 2006/0132819 A1
(43) Pub. Date: Jun. 22, 2006

(54) Computer system having printer driver, print data generating method using the same, and medium recording printer driver

(75) Inventor: Sung-ryong Shin, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/283,739

(22) Filed: Nov. 22, 2005

(30) Foreign Application Priority Data
Dec. 20, 2004 (KR) 2004-0108894

(51) Int. Cl. G06F 3/12

(52) U.S. Cl. 358/1.13

(57) ABSTRACT

A computer system having a printer driver to convert received data into print data according to a user's printing order is provided that enhances printing speed by minimizing the amount of print data that is generated by compressing and converting image data. The printer driver has a determining part to determine whether the received data is image data; an image analysis part to divide the image data into one or more detail areas according to the amount of change between pixel data constituting the image data, and to select a best appropriate compression program applied for each detail area from a plurality of compression programs; a compressing part to compress each detail area by using the best appropriate compression program in the plurality of compression programs; and a converting part to convert compressed data from the compressing part into the print data.

### PRIORITY

This application claims the benefit under 35 U.S.C. §119(a) of Korean Patent Application No. 2004-0108894, filed on Dec. 20, 2004, in the Korean Intellectual Property Office, the entire contents of which are incorporated herein by reference.

### BACKGROUND OF THE INVENTION

1. Field of the Invention

The present invention relates to a computer system having a printer driver, a print data generating method using the same and a medium recording the printer driver. More particularly, the present invention relates to a computer system having a printer driver which minimizes print data by separately compressing image data included in data to print using one or more compression methods, a print data generating method using the same and a medium recording the printer driver.

2. Description of the Related Art

As shown in FIG. 1, a conventional computer system configured to be available for printing comprises a computer 100 and a printer 200 connected to the computer 100. In the computer 100, an application program 110 to write a document and a printer driver 120 are stored.

If a user wants to print a document written using the application program 110 on the computer 100, the user inputs a printing order to the computer 100 when the application program 110 operates. With the input of the printing order, the application program 110 calls the printer driver 120 and sends the printing order to the printer driver 120. Referring to FIGS. 1 and 2, a determining part 121 of the printer driver 120 receives data to print from the application program 110 at operation S110 and determines whether the received data is image data or not at operation S120. If the data to print is determined as non-image data such as text data, the data is directly converted to printing data by a converting part 123 at operation S140 and is transmitted to the printer 200 at operation S150.

If the determining part 121 determines the data to print as the image data, a compressing part 122 compresses the image data at operation S130. After the converting part 123 converts the image data into the printing data at operation S140, the printing data is transmitted to the printer 200 at operation S150. The compressing part 122 uses a compression method such as joint photographic expert group (JPEG) to compress the image data. Thus, when a large amount of the printing data to be transmitted to the printer is generated because of the image data and the like, the printer driver 120 prevents a reduction in printing speed by compressing and transmitting the image data.

However, the conventional printer driver compresses using a single compression method for all types of image data. Although a simple image data may be compressed by an appropriate compression method to accomplish a high compression ratio, only one complicated compression method is used that generates an unnecessarily large amount of printing data and therefore slows down the printing speed.

### SUMMARY OF THE INVENTION

Accordingly, it is an exemplary aspect of the present invention to provide a computer system having a printer driver to enhance a printing speed by minimizing the amount of print data which is generated by compressing and converting image data, a print data generating method using the same and a medium recording the printer driver.

Additional aspects and/or advantages of the present invention will be set forth in part in the description which follows and, in part, will be apparent from the description, or may be learned by practice of the present invention.

The foregoing and/or other exemplary aspects of the present invention are also achieved by providing a computer system having a printer driver to convert received data into print data according to a user's printing order. The printer driver comprises a determining part to determine whether the received data is image data, an image analysis part to divide the image data into one or more detail areas according to the amount of change between pixel data constituting the image data, and to select an appropriate compression program to be applied to respective ones of the detail areas from a plurality of compression programs, a compressing part to compress each detail area by using the most appropriate compression program selected from among the plurality of compression programs; and a converting part to convert compressed data by the compressing part into the print data.

According to another exemplary aspect of the present invention, the computer system further comprises a printing apparatus which receives the print data for the printer driver, and prints the print data.

According to another exemplary aspect of the present invention, a storage medium storing a printer driver comprises sets of instructions to determine whether data to print is image data, divide the image data into one or more detail areas according to the amount of change between pixel data constituting the image data on the basis of the determination, and select the most appropriate compression program to be applied to respective ones of the detail areas from a plurality of compression programs, and compress each detail area by using the compression program selected for that detail area, and convert the data generated by the compression program into print data.

According to another exemplary aspect of the present invention, a print data generating method comprises the steps of: determining whether data to print is image data; dividing the image data into one or more detail areas according to the amount of change between pixel data constituting the image data on the basis of the determination, and selecting the most appropriate compression program to be applied for each detail area from among a plurality of compression programs; compression each detail area by using the most appropriate compression program; and converting data generated by the compression program into print data.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a block diagram of a conventional computer system;

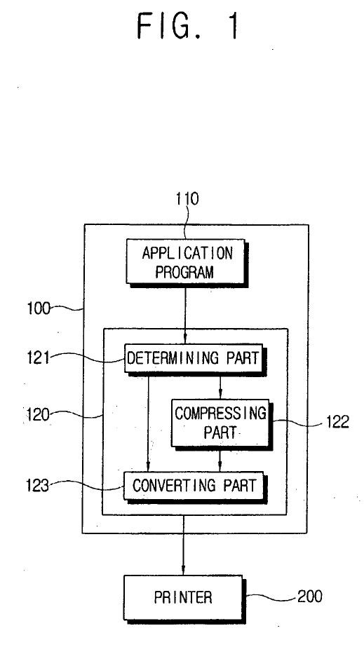

FIG. 2 is a flow diagram showing an operating sequence for the computer system of FIG. 1;

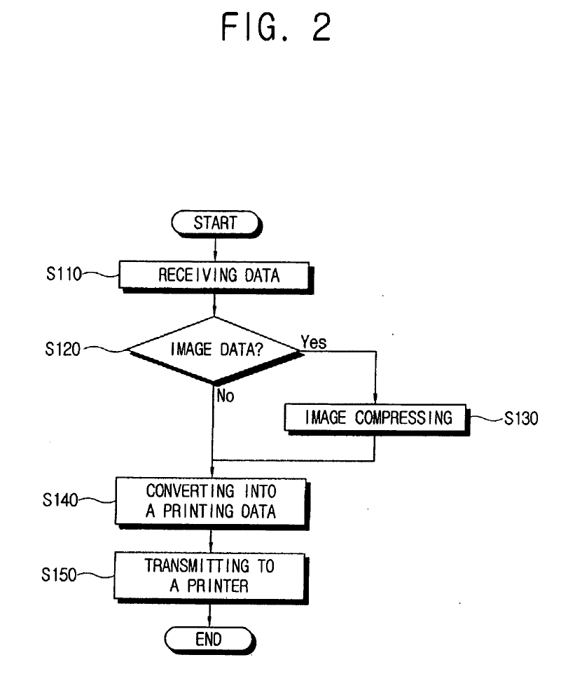

FIG. 3 is a block diagram showing a computer system according to an embodiment of the present invention;

FIG. 4 illustrates exemplary data to be printed using the computer system of FIG. 3; and

FIG. 5 is a flow diagram showing an operating sequence for the computer system of FIG. 3.

### DETAILED DESCRIPTION OF THE EXEMPLARY EMBODIMENTS

Reference will now be made in detail to the embodiments of the present invention, examples of which are illustrated in the accompanying drawings, wherein like reference numerals refer to like elements throughout.

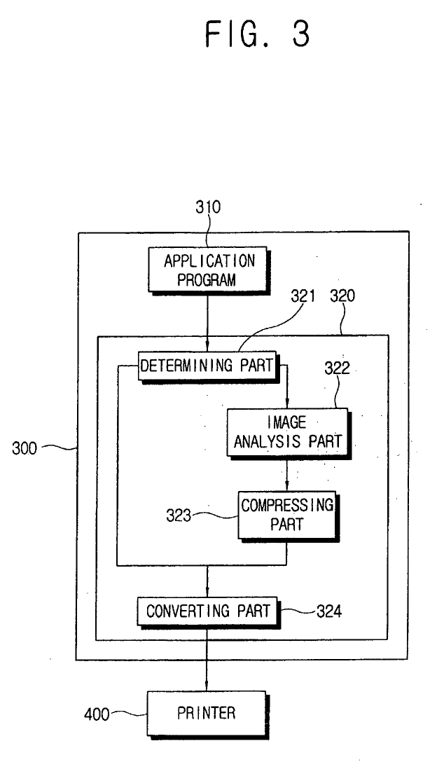

As shown in FIG. 3, a computer system according to an exemplary embodiment of the present invention comprises a computer 300 and a printer 400 connected to the computer 300. The computer 300 comprises a keyboard and a mouse as an input apparatus, a monitor as a display apparatus, and a computer main body having control and storage devices. In the computer 300, an application program 310 for document writing is stored. The application program 310 can be any of various types of programs for generating documents having general text, presentations, diagrams, and graphs, and so on.

Also, in the computer 300 is stored a printer driver 320 to transmit print data to the printer 400. The printer driver 320 converts data received from the application program 310 into the print data which can be recognized by the printer 400, and transmits the print data to the printer 400.

If a user wants to print a document written by the application program 310 on the computer 400, the user inputs a printing order to the computer 400 when the application program 310 is running. After receiving the printing order, the application program 310 calls the printer driver 320 and sends a printing order.

The printer driver 320 comprises a determining part 321 to determine whether data received from the application program 310 is image data or not, an image analysis part 322 to divide the image data into detail areas according to a selected and preferable optimal compression methods (i.e., an optimal compression method can be a compression method that gives a desired compression ratio for a particular type of data), a compressing part 323 to compress the detail area by using one of a plurality of compression programs stored, and a converting part 324 to convert the data which is compressed by the compressing part 323 into the print data.

The determining part 321 receives data to print from the application program 310, and determines whether the received data is image data or not. If the determining part 321 determines that the data to print is not image data but rather text data, for example, the determining part 321 transmits the data to converting part 324 directly. Then, the converting part 324 converts the data into the print data and transmits the print data to the printer 400. If the determining part 321 determines that the data to print is image data, the image analysis part 322 analyzes the image data. The image analysis part 322 analyzes the image data preferably line to line. For example, by reading the image data received through a graphic device interface (GDI) line to line, the image analysis part 322 reads an index value or a RGB value of the pallet to a pixel constituting each line of the image, and sets up a compression area corresponding to an optimal compression method by measuring the change in the index value or the RGB value between neighboring pixels. As a result of the measurements, if the same index value or RGB value is repeated, the image analysis part 322 sets up the area as a run length encoding (RLE) area. When contiguous and similar data is shown repeatedly, the RLE compression method can more simply compress the data. Further, when the value between the lines is not changed, the image analysis part 322 sets up the area as a Delta Row compression area. The Delta Row compression method is a compression method comparing images between lines, and simply compresses the data corresponding to the line when the value of the data between the lines is not different from each other. Meanwhile, when the image data has a data value which is not compressed via one of the two compression methods mentioned above, the image analysis part 322 determines the area to have a large changing value between the pixels and sets up the area as a joint photographic expert group (JPEG) compression area. The JPEG compression method is advantageous as compared to the other two methods when enhancing a compression ratio of complicated image data.

Although the exemplary embodiment described above only employs three compression methods and selects from among these three methods, any number and various kinds of compression methods may be used depending on the printer language and the desired compression ratio of the compression method. However, when there are too many compression methods or when there are many detail areas which have different compression methods, the printing speed may become slower than the case where only one compression method is used. Accordingly, the number of detail parts in the image data is preferably three or four. After dividing the image data into one more compression areas, which are detail areas, a compressing part 323 compresses each of the divided detail areas by the selected and preferably best or appropriate (e.g., optimal) compression method.

Because three compression methods are illustrated in this exemplary embodiment, the compressing part 323 stores the RLE, the Delta Row, and the JPEG compression programs to perform appropriate compression operations.

The image data compressed by the compressing part 323 is converted into the print data by the converting part 324, thereby transmitted to the printer 400.

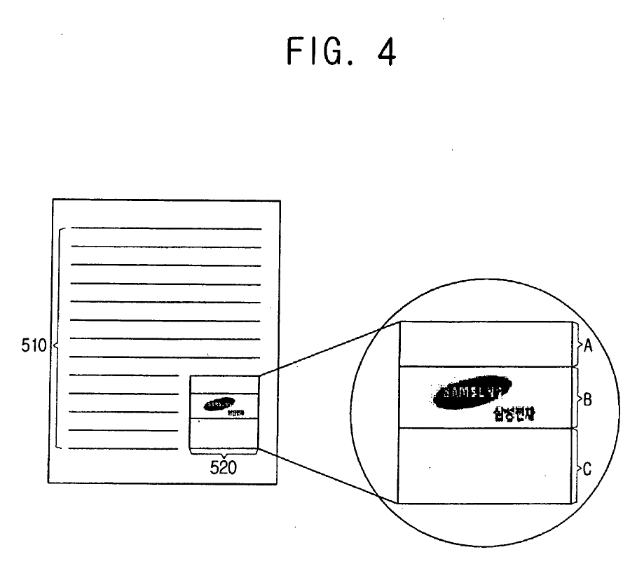

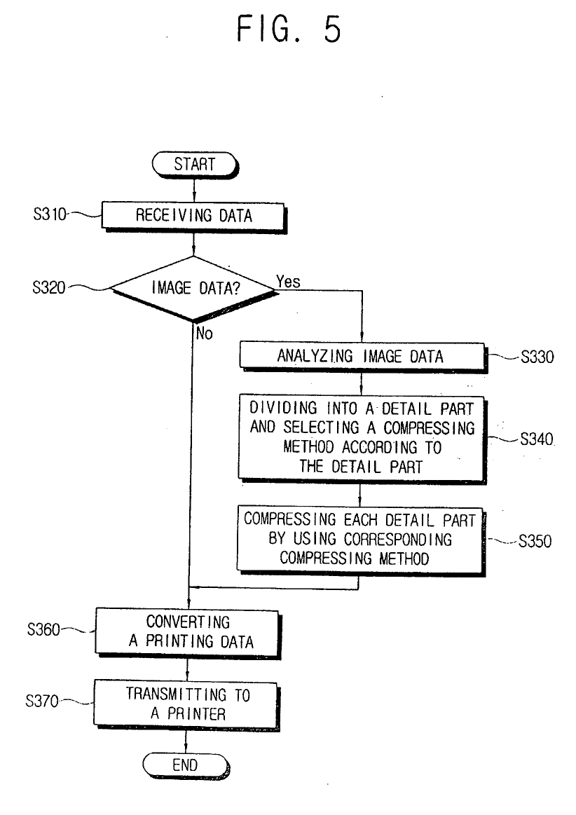

An exemplary embodiment of the print data generating method by the printer driver described above is explained hereinafter by referring to FIG. 5; on the assumption that the printing order to print a document as shown in FIG. 4 is sent by the application program 310.

When a user wants to print a document written by a predetermined application program 310 on computer 300 in FIG. 3, the user inputs a printing order to the specific application program 310. Then, the application program 310 calls a printer driver 320 and orders to print the document.

When receiving the printing order from the application program 310 (at operation S310 in FIG. 5), the printer driver 320 displays register information such as printer information corresponding to the currently connected printer, a size of paper on which to print, the number of sheets to print on a monitor. If the user selects a printing condition through the displayed register information and gives an order to print, the printer driver 320 receives the order and starts operating. Firstly, the determining part 321 transmits a text part 510 (e.g., as shown in FIG. 4) in the document data received from the application program 310 directly to the converting part 324 to convert the text part into print data. Meanwhile, for the image 520 (refer again to FIG. 4), the image analysis part 322 reads the image 520 pixel to pixel and divides it into detail areas. The dividing of the image part 520 may be accomplished as shown in the exploded view of FIG. 4. As the same image is repeated between lines in area A and area C, an RLE and a Delta Row compression methods may be applicable. In this exemplary embodiment of the invention, the Delta Row compression method is applied as the best method. Also, for the area B, the JPEG compression method is applied as the best method because changes between the pixels constituting the image are more complicated (operation S340).

Once the best compression methods are selected for the detail areas of the image data, the image analysis part 322 transmits the detail areas to the compressing part 323 to compress the image data (operation S350). The compressing part 323 compresses the area A by using the Delta Row compression method, the area B by using the JPEG compression method, finally the area C by using the Delta Row compression method. The data compressed in the compressing part 323 is converted into the print data in the converting part 324 (operation S360), and the print data is transmitted to the printer 200 at operation S370.

The above compression procedure of the printer driver may be set to be an option that is configurable according to a user's selection. That is, when the printer driver is called by receiving a printing order from the application program 310, it may display a menu such as “image auto dividing compression” with the register information on the monitor. If a user to selects the “image auto dividing compression” option, more than one compression method is used in accordance with the present invention as described above. If the user does not select the “image auto dividing compression” option from the menu, the image data is compressed using a conventional single compression method.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A computer system having a printer driver to convert received data into print data according to a user's printing order, wherein the printer driver comprises:
a determining part to determine whether the received data is image data;
an image analysis part to divide the image data into one or more detail areas according to the amount of change between pixel data constituting the image data, and to select an optimal compression program for each detail area from a plurality of compression programs;
a compressing part to compress each detail area by using the selected compression program for that detail area; and
a converting part to convert compressed data corresponding to each detail are generated by the compressing part into the print data.

2. The computer system according to claim 1, wherein the determining part is further operable to transmit the received data directly to the converting part when the received data is not determined to be image data.

3. The computer system according to claim 1, wherein the image analysis part is operable to analyze the image data line to line.

4. The computer system according to claim 3, wherein the image data is received through a graphic device interface (GDI), the image analysis part being operable to read at least one of an index value and a red/green/blue or RGB value to a pixel composing each line of the image, and to set up a detail area corresponding to an optimal one of the plurality of compression programs by measuring the change in the index value or the RGB value between neighboring pixels.

5. The computer system according to claim 4, wherein the image analysis part being operable to, if the same index value or RGB value is repeated, set up the detail area as a run length encoding (RLE) area.

6. The computer system according to claim 3, wherein the image analysis part is operable to, when a measured value between the lines is not changed, set up the detail area as a Delta Row compression area.

7. The computer system according to claim 3, wherein the image analysis part being operable to set up the detail area as a joint photographic expert group (JPEG) compression area when the image analysis part determines the detail area to have a large changing value between the pixels.

8. The computer system according to claim 1, wherein the printer driver is configured to generate and display a menu allowing a user to select one of a first mode and a second mode, a single compression method being used by the printer driver when operating in the first mode, and the printer driver dividing image data and selecting from among the plurality of compression programs when operating in the second mode.

10. The computer system according to claim 1, further comprising a printing apparatus which receives the print data from the printer driver and prints the print data.

11. A storage medium for storing a printer driver, comprising;
a first set of instructions for determining whether data to print is image data;
a second set of instructions for dividing the image data into one or more detail areas according to the amount of change between pixel data constituting the image data;
a third set of instructions for selecting a compression program for each detail area from a plurality of compression programs;
a fourth set of instructions for compressing each detail area by using the selected compression program; and
a fifth set of instructions for converting the data generated by the compression program into print data.

12. A print data generating method, comprising the steps of:
determining whether data to print is image data;
dividing the image data into one or more detail areas according to the amount of change between pixel data constituting the image data;
selecting a compression program to be applied for each detail area from a plurality of compression programs;
compressing each detail area by using the selected compression program; and
converting data generated by the compression step into print data.

13. The print data generating method according to claim 12, wherein the dividing step further comprises the step of analyzing the image data line to line.

14. The print data generating method according to claim 13, wherein the dividing step further comprises the steps of:
reading at least one of an index value and a red/green/blue or RGB value to a pixel composing each line of the image; and
setting up a detail area corresponding to an optimal one of the plurality of compression programs by measuring the change in the index value or the RGB value between neighboring pixels.

15. The print data generating method according to claim 14, wherein the dividing step further comprises the step of setting up the detail area as a run length encoding (RLE) area if the same index value or RGB value is repeated.

16. The print data generating method according to claim 13, wherein the dividing step further comprises the step of setting up the detail area as a Delta Row compression area when a measured value between the lines is not changed.

17. The print data generating method according to claim 13, wherein the dividing step further comprises the step of setting up the detail area as a joint photographic expert group (JPEG) compression area when detail area has a large changing value between the pixels.

18. The print data generating method according to claim 12, further comprising the steps of:
generating and displaying a menu allowing a user to select one of a first mode and a second mode;
using a single compression method when the first mode is selected from the menu; and
dividing image data and selecting from among the plurality of compression programs when the second mode is selected from the menu.
